(19) United States
(12) Patent Application Publication
(10) Pub. No.: US 2007/0014339 A1
(43) Pub. Date: Jan. 18, 2007

(54) Data communication system

(75) Inventors: Yo Yanagida, Susono-shi (JP); Naoyuki Shiraishi, Susono-shi (JP); Atsushi Kawamura, Susono-shi (JP); Terumitsu Sugimoto, Susono-shi (JP)

Correspondence Address: SUGHRUE MION, PLLC, 2100 PENNSYLVANIA AVENUE, N.W., SUITE 800, WASHINGTON, DC, 20037, US

(73) Assignee: YAZAKI CORPORATION

(21) Appl. No.: 11/179,584

(22) Filed: Jul. 13, 2005

(51) Int. Cl. H04L 5/16

(52) U.S. Cl. 375/220

(57) ABSTRACT

A data communication system includes a fist transceiver and a second transceiver. The first transceiver includes a first main clock generator that generates a first main clock, a first receiver that receives a signal transmitted from the second transceiver, a regulation signal generator that generates a regulation signal based on the received signal, and a first transmitter that transmits the regulation signal to the second transceiver. The second transceiver includes a second main clock generator that generates a second main clock, a second transmitter that transmits the signal to the first transceiver, a second receiver that receives the regulation signal from the first transceiver, and a regulator that regulates the main clock frequency of the second main clock generator so as to match with a main clock frequency of the first main clock generator based on the regulation signal.

### BACKGROUND OF THE INVENTION

The present invention relates to a data communication system arranged to correct the main clock frequency of another transceiver based on a transmission signal generated in one transceiver.

In a data communication system where a master transceiver and a plurality of slave transceivers perform bidirectional communications, each of the transceivers 6-1 through 6-4 incorporates a quartz oscillator or a ceramic oscillator 7 in order to use the oscillation signal of respective oscillator as a main clock to perform signal processing and data communications, as shown in FIG. 8. The quartz oscillator and the ceramic oscillator have a high-accuracy oscillation frequency and low temperature dependence. By using one of these as a main clock of each transceiver and mounting oscillators whose oscillation frequencies are equal to each other on the transceivers 6-1 through 6-8, it is possible to provide high-transmission-quality communications whose coding error rate is small even when software processing in the communicating section is made common and simplified across the transceivers.

Generally, in a half-duplex data communication system using a single carrier signal, each of the transceivers 6-1 through 64 incorporates a quartz oscillator or a ceramic oscillator 7 in order to use the oscillation signal of respective oscillator as a carrier signal to perform data communications, as shown in FIG. 8. The quartz oscillator and the ceramic oscillator have a high-accuracy oscillation frequency and low temperature dependence. By using one of these as an oscillator for generating a carrier signal and mounting oscillators whose oscillation frequencies are equal to each other on the transceivers 6-1 through 6-8, it is possible to provide high-transmission-quality communications whose coding error rate is small (refer to JP-A-10-276105 and JP-A-10-285027).

The quartz oscillator and the ceramic oscillator are very expensive compared with the LC oscillator circuit and the RC oscillator circuit. The problem is that the overall cost of a data communication system becomes higher when such an expensive component is mounted on each transceiver.

### SUMMARY OF THE INVENTION

The invention has been accomplished in view of the above circumstances and has as an object to provide a data communication system whose transmission quality is high while minimizing the number of quartz oscillator or ceramic oscillators to be used.

In order to attain the object, the invention provides A data communication system, comprising:

a fist transceiver; and

a second transceiver that communicates with the first transceiver,

wherein the first transceiver includes:
a first main clock generator that generates a first main clock;
a first receiver that receives a signal transmitted from the second transceiver;
a regulation signal generator that generates a regulation signal based on the received signal to regulate a main clock frequency of the second main clock generator of the second transceiver; and
a first transmitter that transmits the regulation signal to the second transceiver; and

wherein the second transceiver includes:
a second main clock generator that generates a second main clock;
a second transmitter that transmits the signal to the first transceiver, the signal including information regarding the second main clock;
a second receiver that receives the regulation signal from the first transceiver; and
a regulator that regulates the main clock frequency of the second main clock generator so as to match with a main clock frequency of the first main clock generator based on the received regulation signal.

Preferably, the first main clock is higher than the second main clock in frequency accuracy and frequency stability.

Preferably, the first transceiver is a master device and the second transceiver is a slave device.

Preferably, the communication between the first transceiver and the second transceiver use a single carrier signal as the signal to perform modulation/demodulation.

Preferably, the communication between the first transceiver and the second transceiver use a single carrier signal as the signal to perform half-duplex intercommunication.

Preferably, the first main clock generator is either a quartz oscillator or a ceramic oscillator.

Preferably, the second transmitter transmits a carrier signal as the signal which is generated on the basis of the second main clock. The first transceiver includes a carrier frequency calculator that calculates a carrier frequency of the carrier signal based on the carrier signal received by the first receiver. The regulation signal generator generates the regulation signal based on the calculated carrier frequency.

Preferably, the second main clock generator generates the second main clock based on an input signal voltage. The regulator regulates the input signal voltage so that the main clock frequency of the second main clock generator matches with the main clock frequency of the first main clock generator based on the regulation signal.

In the data communication system thus configured, the master device calculates, based on a receive signal received from a slave device, the frequency of the carrier signal generated by the slave device transmitting the receive signal. The master device generates a carrier regulation signal based on the frequency and transmits the carrier signal to the slave device. The slave device regulates the input signal voltage of the second main clock generator of the device based on the regulation signal received from the master device to cause the oscillation frequency of the main clock generator of the slave device to match the oscillation frequency of the main clock generator of the master device.

The data communication system can use a low-cost oscillator circuit such as an RC oscillator circuit or an LC oscillator circuit to be mounted on each slave device in case its master device includes a quartz oscillator or a ceramic oscillator for generating a reference carrier signal. This minimizes the number of quartz oscillators or ceramic oscillators to be used in the system thereby implementing the system at a low cost.

The invention has been summarized above. By reading the best embodiments referring to the attached drawings, the invention will be understood in detail.

### BRIEF DESCRIPTION OF THE DRAWINGS

The above objects and advantages of the present invention will become more apparent by describing in detail preferred exemplary embodiments thereof with reference to the accompanying drawings, wherein:

FIG. 1 is a conceptual diagram showing an exemplary configuration of a data communication system according to the invention;

FIG. 2 shows a frame structure in communications using the LIN protocol;

FIG. 3 is a block diagram showing an exemplary configuration of a master device and a slave device in a data communication system according to the invention;

FIG. 4 is a block diagram showing another exemplary configuration of a master device and a slave device in a data communication system according to the invention;

FIG. 5 is a block diagram showing another exemplary configuration of a master device and a slave device in a data communication system according to the invention;

FIG. 6 illustrates modulation processing in a master device;

FIG. 7 illustrates demodulation processing in a slave device; and

FIG. 8 is a conceptual illustration of a related art data communication system.

### DETAILED DESCRIPTION OF THE PREFERRED EMBODIMENTS

Preferable embodiments of the invention will be detailed referring to drawings.

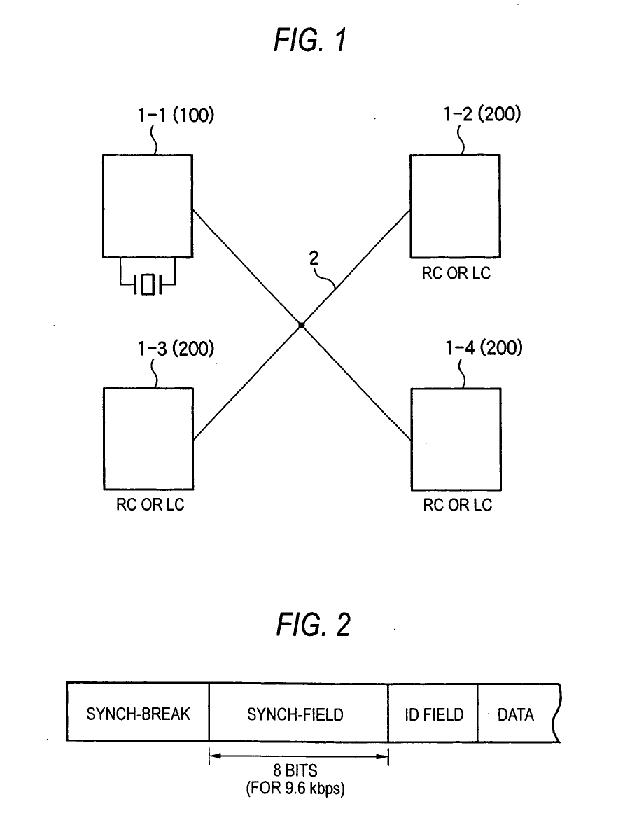

FIG. 1 is a conceptual diagram showing an exemplary configuration of a data communication system according to the invention. In this example, one transceiver 1-1 out of the plurality of (four in this example) communicatively interconnected transceivers 1-1, 1-2, 1-3 and 1-4 functions as a master device 100 while the other devices function as slave devices 200. The data communication system is part of a vehicle-mounted communication system that uses PLC (Power Line Communication) and employs the LIN (Local Interconnect Network) protocol. The system uses a power line 2 for feeding poser to a vehicle-mounted device as a signal transmission path to perform data communications in order to control the vehicle-mounted devices. In the communications that are based on the LIN protocol, Synch-Field and Synch-Break are transmitted before a frame header (ID-Field) (refer to FIG. 2).

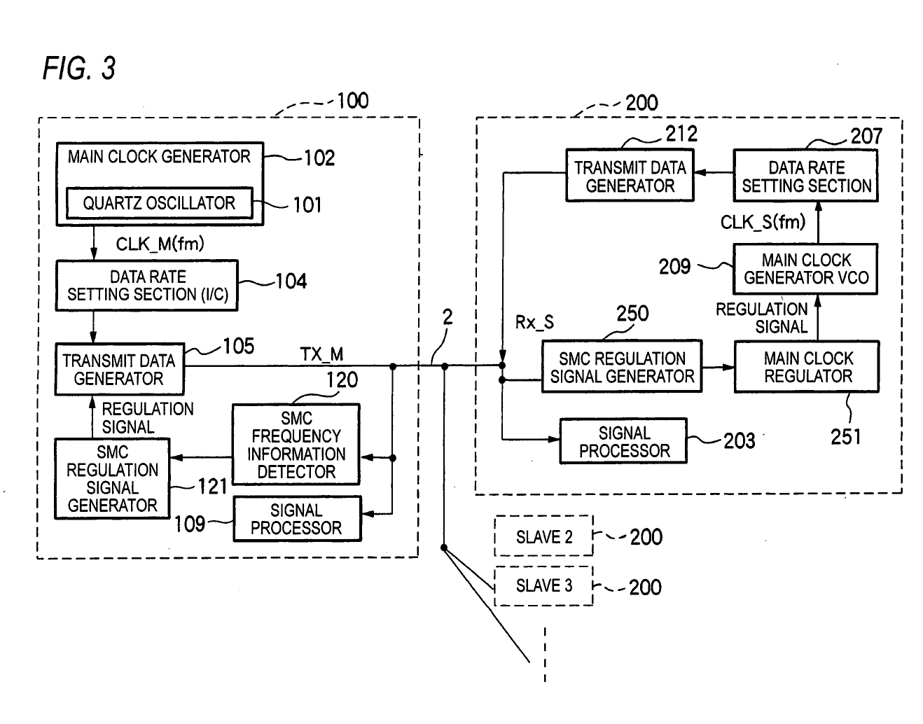

FIG. 3 is a block diagram showing an exemplary configuration of a master device and a slave device in the above data communication system.

A master device 100 includes a main clock generator 102 incorporating a quartz oscillator 101. The main clock generator 102 outputs the oscillation signal of the quartz oscillator 101 as a main clock signal CLK_M (frequency: fm). The main clock signal CLK_M is input to a data rate setting section 104. The data rate setting section 104 sets the transmission rate of transmit data by dividing the main clock signal CLK_M in accordance with a constant C. The set value is input to a transmit data generator 105.

An SMC frequency information detector 120 reads the main clock frequency information of the slave device 100 included in a receive signal and provides the information to an SMC regulation signal generator 121. The term “SMC” is an abbreviation of “a slave-mounted clock” that means a clock mounted on a slave device”.

The SMC regulation signal generator 121 generates a regulation signal for regulating the main clock frequency fs of a corresponding slave device 200 to cause it to match the main clock frequency of the master device 100 based on the main clock frequency information provided by the SMC frequency information detector 120, and provides the resulting signal to a transmit data generator 105.

The transmit data generator 105 generates transmit data TX_M based on the set value specified by the data rate setting section 104 and the regulation signal generated in the SMC regulation signal generator. The transmit data TX_M is transmitted to the power line 2.

The signal transmitted from the slave device 200 via the power line is input to a signal processor 109 and undergoes signal processing.

The slave device 200 includes, as a main clock generator 209, a VCO consisting of an RC oscillator circuit or an LC oscillator circuit that uses a variable-capacity diode. In the slave device 200, a signal Rx_S transmitted via the power line 2 is input to a signal processor 203 and an SMC regulation signal detector 250. The signal processor 203 processes the receive signal Rx_S.

The SMC regulation signal detector 250 detects the SMC regulation signal included in a receive signal from the master device 100 and provides the signal to a main clock regulator 205.

The main clock regulator 205 generates a regulation signal for regulating the main clock frequency fs of the slave device 200 to cause it to match the main clock frequency fm of the master device 100 and provides the regulation signal to a main clock generator 209.

The main clock generator 209 transmits the generated main clock signal CLK_S to a data rate setting section 207 while regulating the main clock frequency to the regulation signal from the main clock regulator 205.

The data rate setting section 207 sets the transmission rate of transmit data by dividing the main clock signal CLK_S generated by the main clock generator 209 in accordance with a constant C and transmits the set value to a transmit data generator 212.

The transmit data generator 212 generates transmit data TX_S at the transmission rate set by the data rate setting section 207.

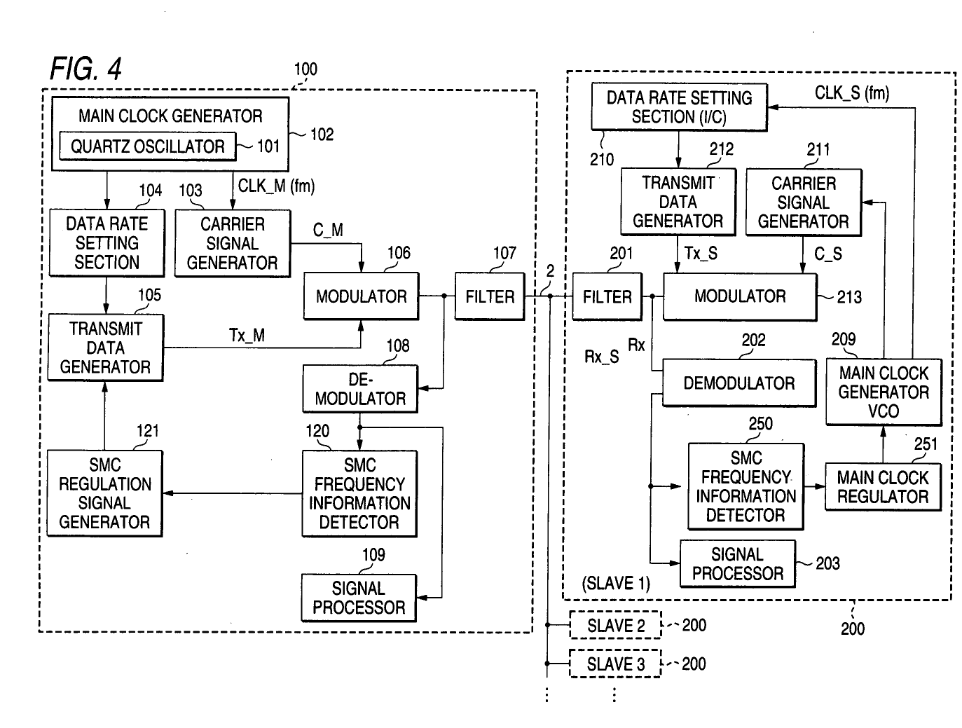

FIG. 4 is a block diagram showing another exemplary configuration of a master device and a slave device in the inventive data communication system.

A master device 100 includes a main clock generator 102 incorporating a quartz oscillator 101. The main clock generator 102 outputs the oscillation signal of the quartz oscillator 101 as a main clock signal CLK_M (frequency: fm). The main clock signal CLK_M is input to a data rate setting section 104 and a carrier signal generator 103. The data rate setting section 104 sets the transmission rate of transmit data by dividing the main clock signal CLK_M in accordance with a constant C. The set value is input to a transmit data generator 105.

The carrier signal generator 103 processes the main clock signal CLK_M generated by the main clock generator 102 to generate a carrier signal C_M.

A signal transmitted from the slave device 200 via a power line 2 is input to a demodulator 108 via a band-pass filter 107. A receive signal demodulated by the demodulator 108 is input to a signal processor 109 and an SMC frequency information detector 120. The signal processor 109 processes the receive signal.

The SMC frequency information detector 120 reads the main clock frequency information of the slave device 100 included in the receive signal and provides the information to an SMC regulation signal generator 121.

The SMC regulation signal generator 121 generates a regulation signal for regulating the main clock frequency fs of a corresponding slave device 200 to cause it to match the main clock frequency of the master device 100 based on the main clock frequency information provided by the SMC frequency information detector 120, and provides the resulting signal to a transmit data generator 105.

The transmit data generator 105 generates transmit data TX_M based on the set value specified by the data rate setting section 104 and the regulation signal generated in the SMC regulation signal generator 121. The transmit data TX_M is transmitted to a modulator 106.

The modulator 106 modulates the carrier signal C_M in accordance with the transmit data Tx_M. The input signal of the modulator 106 is transmitted to the power line 2 via the band-pass filter 107.

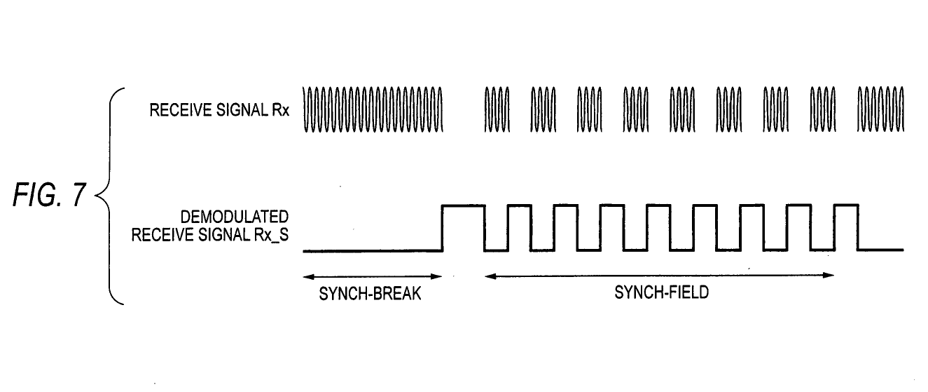

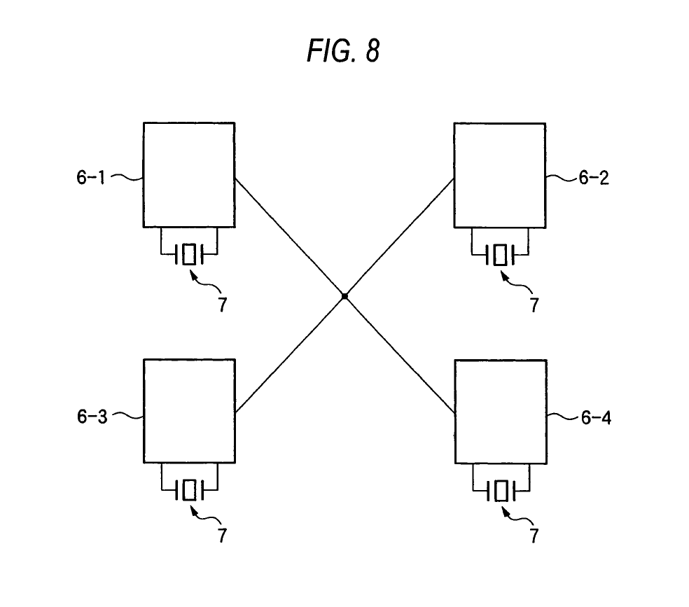

The slave device 200 includes, as a main clock generator 209, a VCO consisting of an RC oscillator circuit or an LC oscillator circuit that uses a variable-capacity diode. In the slave device 200, a signal transmitted via the power line 2 is input to a demodulator 202. The demodulator 202 demodulates a receive signal Rx (refer to FIG. 7). The demodulated receive signal Rx_S is input to a signal processor 203 and an SMC regulation signal detector 250. The signal processor 203 processes the receive signal Rx_S.

The SMC regulation signal detector 250 detects an SMC regulation signal included in the receive signal Rx_S.

A main clock regulator 251 generates a regulation signal for regulating the main clock frequency fs of the slave device 200 to cause it to match the main clock frequency fm of the master device 100. The generated regulation signal is transmitted to a main clock generator 209.

The main clock generator 209 transmits the generated main clock signal CLK_S (fs) to a data rate setting section 210 and a carrier signal generator 211 while regulating the main clock frequency of the slave device 200 to the regulation signal from the main clock regulator 251.

The data rate setting section 210 sets the transmission rate of transmit data by dividing the main clock signal CLK_S (fs) generated by the main clock generator 209 in accordance with a constant C. The set value is transmitted to a transmit data generator 212.

The transmit data generator 212 generates transmit data TX_S at the transmission rate set by the data rate setting section 210. The carrier signal generator 211 processes the main clock signal CLK_S generated by the main clock generator 209 to generate a carrier signal C_S. The transmit data TX_S and the carrier signal C_S are transmitted to a modulator 213.

The modulator 213 modulates the carrier signal C_S in accordance with the transmit data Tx_S. The input signal of the modulator 213 is transmitted to the power line 2 via the band-pass filter 107.

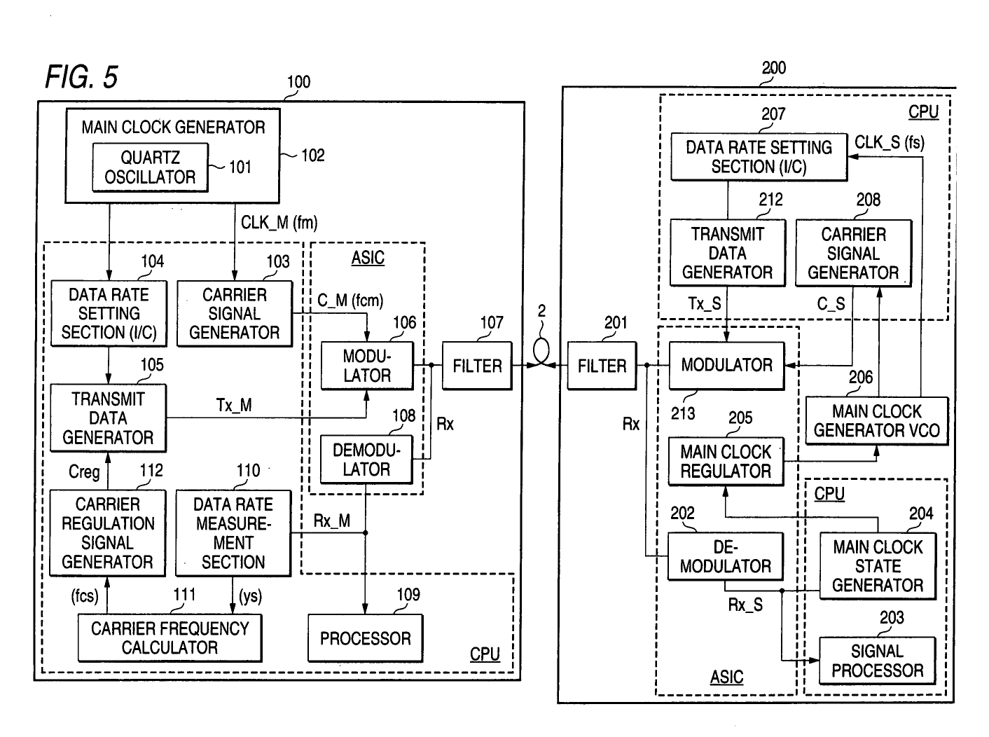

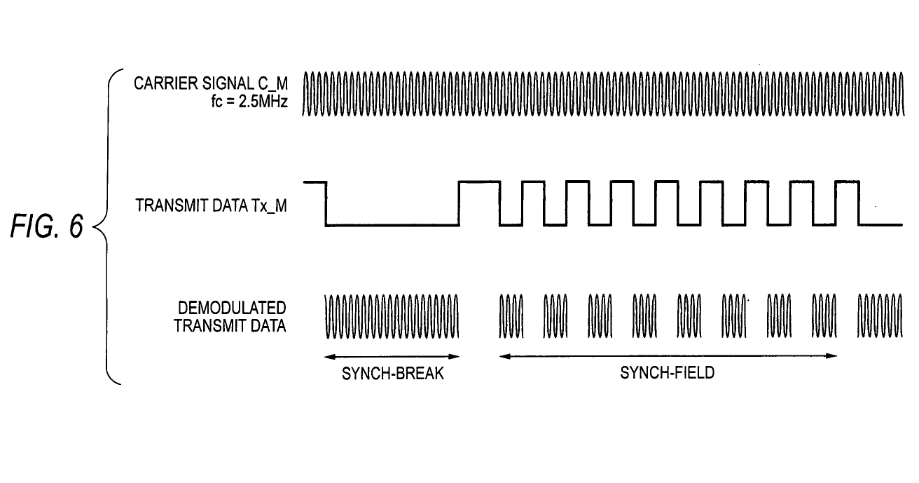

FIG. 5 is a block diagram showing another exemplary configuration of a master device and a slave device in the inventive data communication system.

A master device 100 includes a main clock generator 102 incorporating a quartz oscillator 101. The main clock generator 102 outputs the oscillation signal of the quartz oscillator 101 as a main clock signal CLK_M (frequency: fm). The main clock signal CLK_M is input to a carrier signal generator 102 and a data rate setting section 104. The carrier signal generator generates a carrier signal C_M having a predetermined frequency fcm by dividing the main clock signal CLK_M.

The data rate setting section 104 divides the main clock signal CLK_M by a constant C. The set value is input to a transmit data generator 105.

The modulator 106 modulates the carrier signal C_M in accordance with the transmit data Tx_M. The input signal of the modulator 106 is transmitted to a power line 2 via a band-pass filter 107.

The signal Rx transmitted from the slave device 200 is input to a demodulator 108 via the band-pass filter 107. The demodulator 108 demodulates the receive signal Rx (refer to FIG. 7). The receive signal Rx_M demodulated by the demodulator 108 is input to a signal processor 109 and a data rate measurement section 110. The signal processor 109 performs load control processing in accordance with the receive signal.

A carrier frequency calculator 111 calculates the frequency fcs of the carrier signal C_S of a source slave device 200 based on a data rate ys obtained by the data rate measurement section 110. The output of the carrier frequency calculator 111 is input to a carrier regulation signal generator 112.

The carrier regulation signal generator 112 generates a carrier regulation signal Creg based on a calculated value obtained by the carrier frequency calculator 111. The output of the carrier regulation signal generator 112 is input to the transmit data generator 105. The transmit data generator 105 generates transmit data Tx_M including the carrier regulation signal Creg destined for the source slave device 200. The transmit data Tx_M including the carrier regulation signal Creg is transmitted to the source slave device 200 via the band-pass filter 107 and the power line 2.

The slave device 200 includes, as a main clock generator 206, a VCO consisting of an RC oscillator circuit or an LC oscillator circuit that uses a variable-capacity diode. In the slave device 200, a signal Rx_S transmitted via the power line 2 is input to a demodulator via the band-pass filter 201. The demodulator 202 demodulates the receive signal Rx. The demodulated receive signal Rx_S is input to a signal processor 203 and a main clock state detector 204. The signal processor 203 performs load control processing in accordance with the receive signal Rx_S.

The main clock state detector 204 analyzes the carrier regulation signal Creg in the receive signal Rx_S and then generates and outputs a control signal corresponding to the analysis result. The control signal is generated based on the carrier regulation signal Creg in order to regulate the oscillation frequency fs of the main clock generator to cause it to match the oscillation frequency of the main clock generator 102 of the master device 100. The output of the main clock state detector 204 is input to a main clock frequency regulator 205.

The main clock frequency regulator 205 outputs a signal having a voltage corresponding to the control signal from the main clock state detector 204. The output of the main clock frequency regulator 205 is input to the main clock generator 209.

The main clock generator 209 outputs a clock signal CLK_S having a frequency fs corresponding to the input signal voltage from the main clock frequency regulator 205. As the input signal voltage of the main clock generator 209 is regulated in accordance with the carrier regulation signal Creg from the master device 100, the frequency fs of the clock signal CLK_S generated by the clock generator 209 is adjusted to match the frequency fm of the clock signal CLK_M generated by the main clock generator 102 of the master device 100. The clock signal CLK_S output from the master clock generator 209 is input to a data rate setting section 207 and a carrier signal generator 208.

The data rate setting section 207 set a transmit data rate by dividing the clock signal CLK_S generated by the main clock generator 209 in accordance with a constant C. The set value is input to the transmit data generator 212. The transmit data generator 212 generates transmit data Tx_S. The carrier signal generator 208 generates a carrier signal C_S having a predetermined frequency fcs (=fcm) by dividing the clock signal CLK_S. The carrier signal C_S and the transmit data Tx_S are transmitted to a modulator 213. The modulator 213 modulates the carrier signal C_S in accordance with the transmit data Tx_S. The output signal of the modulator 213 is transmitted to the power line via the band-pass filter 201.

As mentioned above, in a data communication system according to this example, the master device 100 calculates a main clock frequency generated by the source slave device 200 transmitting the receive signal Rx_M in accordance with the signal RX_M received from the slave 200 and generates the carrier regulation signal Creg based on the main clock frequency fcs. Each slave device 200 regulates the input signal voltage of the main clock generator of the slave device based on the carrier regulation signal Creg received from the master device 100 to cause the oscillation frequency fs of the main clock generator 206 of the slave device to match the oscillation frequency fm of the main clock generator 102 of the master device 100.

Thus, according to the data communication system, it is possible to cause the clock signal CLK_S of each slave device 200 to match the main clock signal CLK_M of the master device 100 including the expensive quartz oscillator 101 while using an inexpensive component such as an RC oscillator circuit or an LC oscillator circuit in the main clock generator 206 of each slave device 200. This provides a data communication system of a high transmission quality in a cost-effective fashion, same as a case where the quartz oscillator is mounted on every transceiver.

The main clock signal regulation processing on each slave device 200 may be made sequentially during data communications accompanied by actual load control.

The invention is not limited to aforementioned embodiments but various changes or improvements of the invention are possible as required. The form, quantity, and location of each component in the foregoing embodiments are arbitrary as long as the purpose of the invention is attained and are not limited.

While a data communication system using PLC has been described in the above embodiments, the invention is also applicable to a data communication system that uses a leased transmission line. A communications protocol used is not limited to LIN.

What is claimed is:

1. A data communication system, comprising:
a fist transceiver; and
a second transceiver that communicates with the first transceiver,
wherein the first transceiver includes:
a first main clock generator that generates a first main clock;
a first receiver that receives a signal transmitted from the second transceiver;
a regulation signal generator that generates a regulation signal based on the received signal; and
a first transmitter that transmits the regulation signal to the second transceiver; and
wherein the second transceiver includes:
a second main clock generator that generates a second main clock;
a second transmitter that transmits the signal to the first transceiver, the signal including information regarding the second main clock;
a second receiver that receives the regulation signal from the first transceiver; and
a regulator that regulates the main clock frequency of the second main clock generator so as to match with a main clock frequency of the first main clock generator based on the received regulation signal.

2. The data communication system as set forth in claim 1, wherein the first main clock is higher than the second main clock in frequency accuracy and frequency stability.

3. The data communication system as set forth in claim 1, wherein the first transceiver is a master device and the second transceiver is a slave device.

4. The data communication system as set forth in claim 1, wherein the communication between the first transceiver and the second transceiver use a single carrier signal as the signal to perform modulation/demodulation.

5. The data communication system as set forth in claim 1, wherein the communication between the first transceiver and the second transceiver use a single carrier signal as the signal to perform half-duplex intercommunication.

6. The data communication system as set forth in claim 1, wherein the first main clock generator is either a quartz oscillator or a ceramic oscillator.

7. The data communication system as set forth in claim 1, wherein the second transmitter transmits a carrier signal as the signal which is generated on the basis of the second main clock;
wherein the first transceiver includes a carrier frequency calculator that calculates a carrier frequency of the carrier signal based on the carrier signal received by the first receiver; and
wherein the regulation signal generator generates the regulation signal based on the calculated carrier frequency.

8. The data communication system as set forth in claim 1, wherein the second main clock generator generates the second main clock based on an input signal voltage; and
wherein the regulator regulates the input signal voltage so that the main clock frequency of the second main clock generator matches with the main clock frequency of the first main clock generator based on the received regulation signal.
